(19) United States
(12) Patent Application Publication
(10) Pub. No.: US 2023/0190045 A1
(43) Pub. Date: Jun. 22, 2023

(54) Method and Apparatus for Cooking Food

(71) Applicant: Mandeep Singh, Hillsboro, OR (US)

(72) Inventor: Mandeep Singh, Hillsboro, OR (US)

(21) Appl. No.: 18/078,901

(22) Filed: Dec. 9, 2022

Related U.S. Application Data
(60) Provisional application No. 63/291,354, filed on Dec. 18, 2021.
(60) Provisional application No. 63/397,393, filed on Aug. 12, 2022.

(51) Int. Cl. A47J 44/00; B25J 11/00; A47J 36/32; A47J 47/01; A47J 36/06; A23L 5/10

(52) U.S. Cl. CPC A47J 44/00; B25J 11/0045; A47J 36/32; A47J 47/01; A47J 36/06; A23L 5/10; A23V 2002/00

(57) ABSTRACT

A cooking device comprises a power supply, a cooking pot, and a hot plate connected to the power supply and on which the cooking pot sits. The hot plate applies heat to the cooking pot. A plurality of food ingredient dispenser compartments is positioned upright in adjacent locations, aligned in a row at a front of the cooking device. A robotic arm consisting of five articulating joints provide a robotic arm with five corresponding degrees of motion. A computing device connected to the robotic arm controls the robotic arm to move the robotic arm according to the five degrees of motion to separately grasp and hold on to each of the plurality of upright food ingredient dispenser compartments, lift each grasped food ingredient dispenser compartment from its respective position in the row at the front of the cooking device, move each lifted food ingredient dispenser compartment to a position above the cooking pot, and rotate each lifted food ingredient dispenser compartment from its upright position substantially about a horizontal axis while positioned above the cooking pot to dispense food ingredients stored therein into the cooking pot.

### CROSS REFERENCE TO RELATED DOCUMENTS

This application claims the benefit of U.S. Provisional Patent Application No. 63/291,354 filed Dec. 18, 2021, and U.S. Provisional Patent Application No. 63/397,393, filed Aug. 12, 2022, the disclosures of which are incorporated by reference herein in their entirety.

### TECHNICAL FIELD

Embodiments of the invention relate to cooking food and in particular to an automatic process and apparatus for cooking food.

### BACKGROUND

Portable or countertop electric cookers, multicookers or crockpots are well known. Multicookers, for example, are electronically controlled, combined pressure cookers and slow cookers, marketed as an all-in-one appliance designed to consolidate the cooking and preparing of food to one device. A problem with these devices is that some or all the food ingredients are added into a cooking pot at the same time, in the beginning of a cooking cycle, or the cooking cycle must be interrupted to manually add food ingredients to the cooking pot at a later time. Yet, many recipes require adding or mixing food ingredients into the cooking pot at various, specific, times and adjusting the cooking temperature at various, specific times, and for specific time periods, since many food ingredients require a different start time for cooking, a different cooking duration and a different cooking temperature. Additionally, while recipes may be shared by users via telephone, video, or online webpage content, the recipes are not received as input by the cooking devices which then directly act on that input to cook food. Rather, users must configure or manually interrupt the cooking devices, to the extent possible to accommodate the requirements of the recipe.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a front right perspective view of an embodiment of the invention.

FIG. 2 illustrates a rear left perspective view of an embodiment of the invention.

FIG. 3 illustrates a bottom left perspective view of an embodiment of the invention.

FIG. 4 illustrates a rear perspective view of dispenser compartments and their respective handles according to an embodiment of the invention.

FIG. 5 illustrates a view of a plurality of spice dispenser compartments and corresponding spice dispensing utensil according to an embodiment of the invention.

FIG. 6 illustrates a view of a cooking pot lid and corresponding handle according to an embodiment of the invention.

FIG. 7 illustrates a NEMA 17 stepper motor with 100:1 reducer according to an embodiment of the invention.

FIG. 8 depicts a robotic joint and an associated stepper motor according to an embodiment of the invention.

FIG. 9 depicts an embodiment of a robotic joint and gripper assembly according to an embodiment of the invention.

FIG. 10 depicts the robotic arm 145 with dimensions from axis to axis, according to one embodiment.

FIG. 11 illustrates electric pumps according to an embodiment of the invention.

FIG. 12 illustrates a functional block diagram of the electrical components of the cooking device according to an embodiment of the invention.

FIG. 13 is a flowchart of a method of operation of the cooking device according to an embodiment of the invention.

FIG. 14 is a front perspective view of a robotic arm according to an embodiment of the invention.

FIG. 15 is a rear perspective view of spice dispenser compartments 170A-170D in accordance with an embodiment of the invention.

### DETAILED DESCRIPTION

An example embodiment of the invention imitates the traditional home cooking process practiced on the Indian-subcontinent, in which many different ingredients for a particular meal or dish are added to a cooking pot at various times throughout the cooking process, and in which frequent stirring of the ingredients in the cooking pot occurs while the meal or dish is being cooked. In particular, the example embodiments add ingredients to the cooking pot at various times and stir the ingredients in the cooking pot at various times as needed using an entirely automated device. For example, a user cleans and prepares (e.g., cuts, dices, minces) different ingredients of their choice, or as instructed by a recipe for a particular meal or dish, then places the prepared ingredients (e.g., diced onions, crushed tomatoes, crushed garlic, minced ginger, chopped potatoes and other vegetables or pulses, e.g., beans, chickpeas etc.) in different dispenser compartments, for example, food or ingredient dispenser compartments, according to embodiments of the invention. Similarly, spices selected by the user, either of their choice or as instructed in a recipe (e.g., salt, pepper and red chili powder) are placed in different dispenser compartments, for example, spice dispenser compartments. Alternatively, two or more ingredients and/or spices may be combined into a dispenser compartment, for example, if the user or a recipe contemplates the two or more ingredients being added to the cooking pot at the same time. The user can then set a time for the contents in each of the food and spice dispenser compartments to be dispensed into the cooking pot. The user may also set the quantity and time to dispense into the cooking pot various liquids (such as oil, water, sauce, or other liquid) maintained in additional dispenser compartments, for example, liquid dispenser compartments if the user so chooses, or as instructed by a recipe.

According to embodiments, the user powers on the cooking device 100 using start switch or button 101, then, using an input/output device such as a touch screen or LCD display screen 102, selects a cooking temperature and starts the cooking process, for example, by pressing start on a touch screen control panel for the cooking device. A source of heat is applied to the cooking pot, and over time, the cooking pot reaches the selected cooking temperature. Then, all physical movements, e.g., dispensing food, spices, liquids into the cooking pot, stirring the ingredients in the cooking pot, removing and replacing a lid on the cooking pot, are carried out by a five degrees of freedom robotic arm. For example, in one embodiment, the robotic arm lifts a lid for cooking pot. The robotic arm then dispenses food ingredients, spices, and liquids from the respective dispenser compartments into the cooking pot at a specified time. The robotic arm can then place the lid back on the cooking pot. At selected times, the robotic arm removes the lid, lifts a utensil such as a spoon or spatula and stirs the ingredients inside the cooking pot. According to an embodiment, the robotic arm grips a utensil such as a tablespoon or spatula and maneuvers it to pick up spices from spice dispenser compartments and place the spices into the cooking pot. In particular, according to an embodiment, the robotic arm grabs the utensil by its handle and vertically lifts the utensil until it clears the utensil holder, then swings the utensil to a position over the top of the cooking pot, lowers the utensil into the cooking pot, and then moves the utensil in along a path that provides a stirring motion, thereby stirring ingredients in the cooking pot. At the end of the cooking cycle, e.g., when the food is fully cooked, the source of heat is controlled to maintain or reduce the temperature of the meal for serving, or the source of heat is turned off

According to embodiments, the specific times at which ingredients are dispensed into the cooking pot may be saved for future use. The times at which various ingredients are dispensed may be adjusted to account for a different quantity or amount of such ingredients in subsequent cooking events. Thus, embodiments of the invention can replicate the cooking process to achieve the same or different results, as desired by the user. Users can share their recipes with others, including the exact temperature and time settings for the cooking device, and ingredients and their quantities, over a communication network such as the Internet and/or a cellular network. Meal kit providers can share recipes that correspond to pre-packaged meal kits that the user purchases. In such an embodiment, the ingredients in the meal kit are places in the various dispenser compartments, and the cooking device, using the meal kit provider's shared recipe is used to configure the cooking device with the programming needed to cook the recipe. These recipes can be maintained in the cloud and accessed by other users to repeat the process.

### Mechanical Structure

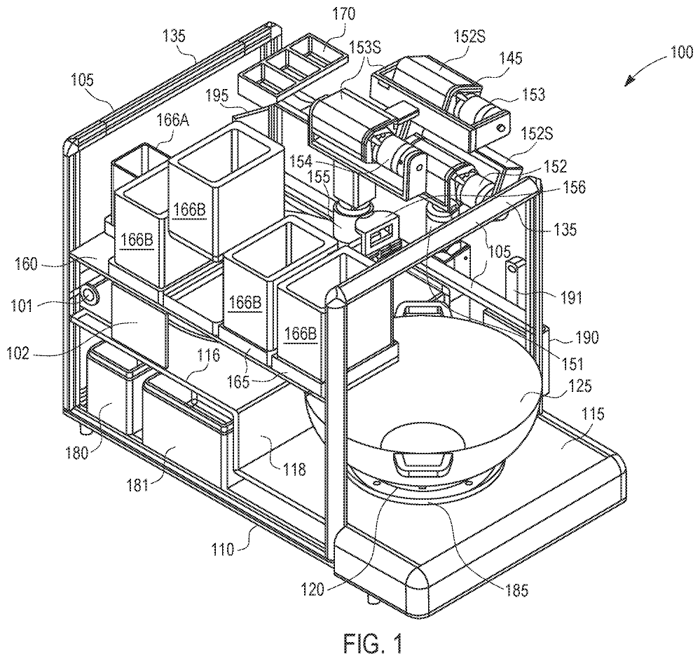

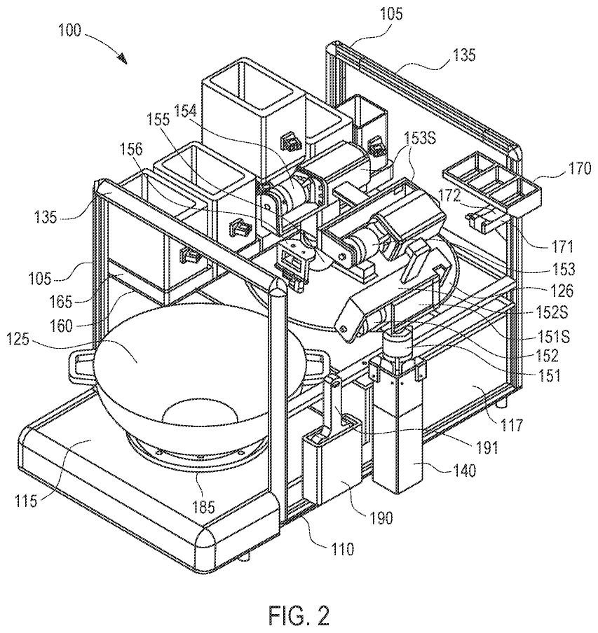

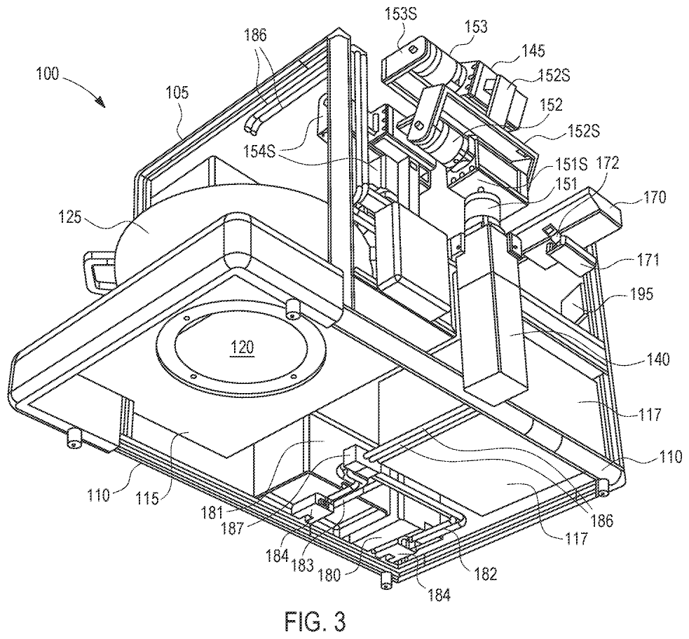

FIG. 1 is a front perspective view of an automatic cooking device 100 according to embodiments of the invention. FIGS. 2 and 3 are rear perspective views of the automatic cooking device 100. With reference to FIGS. 1-3, the cooking device 100 comprises a frame 105. In one embodiment, the frame 105 comprises, for example, rounded v-slot aluminum 6061/3003 (nickel platted aluminum) or stainless steel 316L bars. The frame 105 is assembled to form a cuboid shape, according to an embodiment. The frame 105 includes front and back bottom horizontal members 110. A platform 115, for example, comprising stainless steel sheet metal, is mounted on horizontal members 110 and houses or supports a source of heat, such as an electric hotplate 120 on which the cooking pot 125, sits. Alternatively, the source of heat may be an induction-based coil. The overall outer dimensions of the frame 105 and platform 115 are 675 mm×600 mm×500 mm, according to one embodiment. The overall dimensions make the cooking device suitable for home cooking, where the cooking device sits on a kitchen countertop, and where space may be at a premium.

In an alternative embodiment, there is no platform 115 and no integrated source of heat, such as an electric hotplate 120 on which the cooking pot 125 sits. Rather, the cooking device is placed on a stove top or on a countertop adjacent thereto, such that a gas burner, electric coil, or induction coil on the stove top is used as the source of heat. The cooking pot 125 sits on this source of heat. The cooking device controls the source of heat on the stove top by actuating the stove's own component for controlling the source of heat on the stove, for example, a dial or knob that can be operated to control a gas burner or electric coil on the stove top. In such an embodiment, the cooking device includes a separate actuator that couples to and controls the stove's dial or knob. The actuator comprises a servo motor, a battery and a wireless communication chipset, such as the Seed Studio XIAO ESP32C3 chip that offers Wi-Fi and Bluetooth LE wireless capabilities, so that the cooking device, also equipped with wireless communication capabilities, such as Wi-Fi and Bluetooth capabilities, can pair to and communicate with the actuator to control the stove's dial or knob, and thereby control the source of heat, e.g., a gas burner on the stove, applied to cooking pot 125.

As will be described in further detail below, the advantageous overall dimension is achieved primarily owing to the unique configuration and operation of a robotic arm 145 and the position of the main components of the cooking device, e.g., the dispenser compartments and cooking pot, in relation to one another.

Elevated platform 116 is connected to platform 115 by a vertical panel 118, forming in part a compartment 117 underneath in which electric pumps and electrical equipment for cooking device 125 are situated along with other components such as an AC to DC voltage convertor, a solid-state relay switch to control the power to an electric hotplate 120, and a computing device, such as a microprocessor or microcontroller, that controls and tracks the functioning of the cooking device. Lid 126, when removed from pot 125, can reside atop elevated platform 116 as illustrated in FIG. 2. This elevated platform also has alignment slots cut out in the shape of a ring for the pot lid to rest at a fixed location.

The position of cooking pot 125 relative to the frame 105 allows for steam evaporating from the cooking process to be directed away from the cooking device 100, in particular, when a cover (not shown) is in place over the top of the cooking device 100, bridged between left and right top horizontal members 135, that might otherwise trap such steam. The cover, or separate covers, may also encompass the left, front, and back sides of the cooking device 100, according to an embodiment. The cover(s) may be a polycarbonate or acrylic sheet, or a stainless-steel mesh.

In some embodiments, the robotic arm 145 may remove and replace a lid 126 on the cooking pot 125, as further discussed below. In some embodiments, the lid includes a vent or hole through which moisture, e.g., steam, may escape. The robotic arm 145, in conjunction with one or more cameras and/or depth sensors that provide vision for the robotic arm 145, can rotate the lid when putting it in place or while it is in place on top of the cooking pot so that the moisture is directed outside or away from the cooking device, for example, to the right in the perspective view illustrated in FIG. 1.

FIG. 1 provides yet another illustration of the source of heat, such as electric hotplate 120, housed within on or top of platform 115. The platform 115 comprises a vertical lip along at least a portion of the edges of platform 115. In one embodiment, the vertical lip prevents any liquids or other ingredients spilling over from the cooking pot and then over the edges of platform 115.

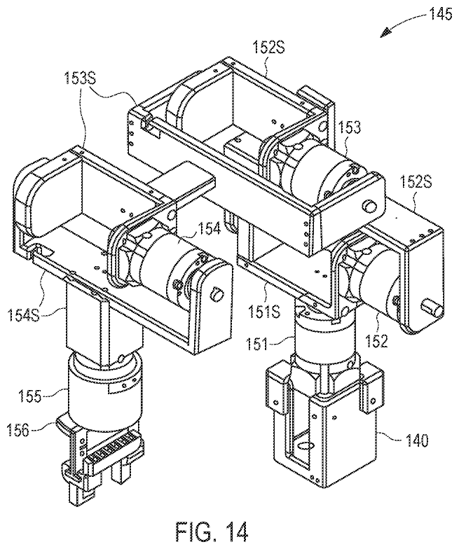

With reference to FIGS. 1 and 14, robotic arm 145 mounts to a base 140 affixed to frame 105, for example, with brackets. The robotic arm 145 consists of five independently articulating joints 151, 152, 153, 154 and 155. According to one embodiment, the articulating joints are made of food grade safe materials, such as aluminum or nickel-plated aluminum The robotic arm's five articulating joints provide five degrees of freedom or motion for the robotic arm, as discussed further below.

Cooking device 100 comprises a dispenser compartment platform 160, on which dispenser compartments 166A and 166B rest, as shown in FIG. 1. In one embodiment, the dispenser compartments are made from injection molded food grade safe polycarbonate. According to one embodiment, dispenser compartments 166B are approximately 130 mm×130 mm×90 mm in size, whereas dispenser compartment 166A is approximately 100 mm×65 mm×60 mm in size. In other embodiments, the dispenser compartments 166A and 166B are approximately the same size. In one embodiment, dispenser compartment alignment rings 165 ensure dispenser compartments 166A and 166B rest in specific and exact locations on the dispenser compartment platform 160, so that the robotic arm 145 can repeatedly and accurately grip and lift and replace each dispenser compartment. The compartment platform is made of nickel-plated aluminum, as are the dispenser compartment alignment rings, according to embodiments. The dispenser compartment rings are fixed to the dispenser compartment platform, for example, by welding the rings to the platform. In one embodiment, the bases of the dispenser compartments 166A and 166B are substantially rectangular, thus, the dispenser compartment alignment rings 165 are likewise substantially rectangular. In one embodiment, the dispenser compartment alignment rings may fully surround the bases of the dispenser compartments, and in other embodiments, the rings may only partially surround the bases, so long as sufficient to maintain correct position and alignment of the respective dispenser compartments atop the dispenser compartment platform. Alternatively, the dispenser compartment platform may have grooves or channels and corresponding ribs or raised portions on the bases of the dispenser compartments provide for maintaining the correct position and alignment of the respective dispenser compartments atop the dispenser compartment platform.

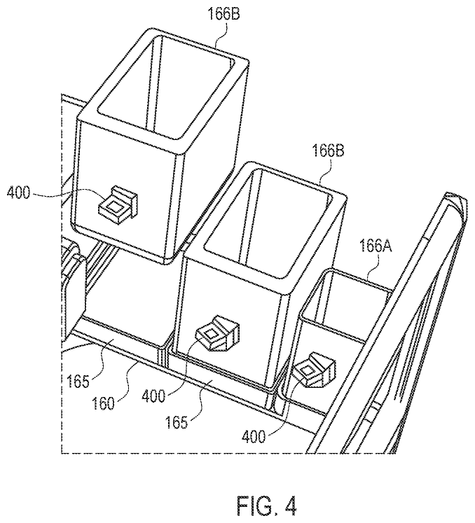

FIG. 4 illustrates details of the dispenser compartment platform 160, dispenser compartment alignment rings 165, and dispenser compartments 166A and 166B. Importantly, each dispenser compartment is aligned with a front plane of the cooking device, so that the user can more easily and rapidly fill each dispenser compartment with ingredients. This is particularly the case where the cooking device 100 is deployed on a kitchen countertop, where the user can only approach and access the cooking device from the front plane the cooking device. Each dispenser compartment 166A and 166B includes a handle 400 by which the robotic arm 145 engages to lift the dispenser compartments, dispense the contents of the dispenser compartments into the cooking pot, and return the dispenser compartments to their respective locations (for example, based on tracking the unique x, y, z coordinates of the locations of each dispenser compartment) atop the dispenser compartment platform 160, within the dispenser compartment alignment rings 165, thereby ensuring the robotic arm 145 can maneuver to the correct location to grab, pick up, and the return the dispenser compartments to their respective locations.

As illustrated in FIGS. 1-3, the dispenser compartments 166A and 166B are aligned along the front plane of cooking device 100. According to one embodiment, the robotic arm 145 is positioned at a back plane of the cooking device that is parallel with the front plane of the cooking device. In one embodiment, the robotic arm 145 is positioned at approximately the center of the width (from left to right) of the cooking device, along the back plane of the cooking device. Given the position and alignment of the dispenser compartments and the position of the robotic arm 145 as described above, handles 400 attached to the back side of each dispenser compartment are fixedly rotated or angled to point to the robotic arm 145, or gripper assembly 156 attached to the end of the robotic arm 145. This angled orientation of handles 400 toward the robotic arm 145/gripper assembly 156 eliminates a sixth degree of freedom requirement in the robotic arm 145, which provides significant cost savings in terms of the robotic arm component of the cooking device according to embodiments of the invention. Importantly, reducing by one the number of degrees of freedom of the robotic arm 145 reduces its complexity and size and cost, thereby contributing to reduction of the overall dimension of, and manufacturing costs for, the cooking device 100. The reduction in dimension and manufacturing cost of the robotic arm 145 makes the cooking device more suitable and convenient for the home-cooking market.

Cooking device 100 comprises a plurality of spice dispenser compartments 170. FIG. 1 illustrates and embodiment with three spice dispenser compartments 170, where each compartment typically stores a different spice, e.g., salt, pepper and red chili. It is appreciated that cooking device 100 may comprise a fewer or a greater number of spice dispenser compartments to support the storage and dispensing of various spices. Each spice compartment is approximately 70 mm×35 mm×26 mm in dimension, according to one embodiment.

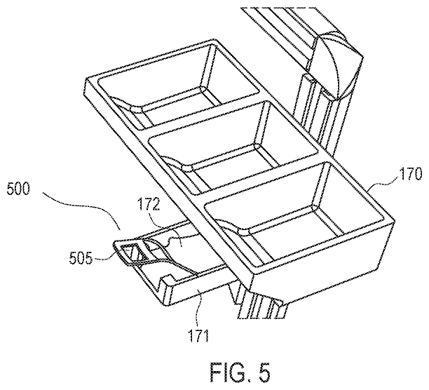

According to one embodiment, the robotic arm uses a utensil 172 to scoop and dispense spices from the spice dispenser compartments 170 into cooking pot 125. In one embodiment, the utensil is a spoon. The utensil 172 may be held in a tray 171 when not in use. With reference to FIG. 5, according to an embodiment, the utensil 172 has a handle 500 that can be gripped by the robotic arm 145, and in particular, by gripper assembly 156 at the end of robotic arm 145, which can then move the utensil to pick up or scoop spice held in any one of the spice dispenser compartments and place the spice in cooking pot 125. According to one embodiment, the handle 500 has a hole, for example, a square hole 505 with round inside edges, by which the robotic arm's gripper assembly 156 holds at the utensil. In an alternative embodiment, each spice dispenser compartment 170 has its own handle and is positioned within a dispenser compartment ring, in the same manner as the food dispenser compartments 166A and 166B. According to such an embodiment, the robotic arm/gripper assembly picks up, maneuvers, and returns a spice dispenser compartment 170 in the same manner as the food dispenser compartments 166A and 166B and/or the utensil 190, as described elsewhere herein.

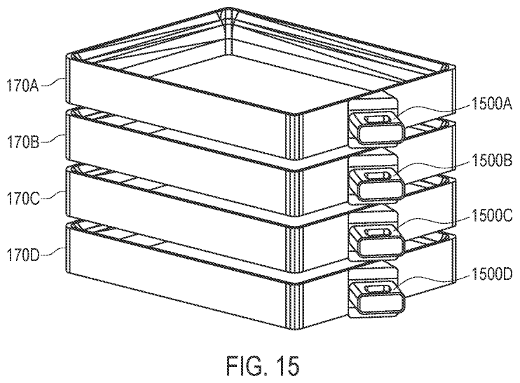

With reference to FIG. 15, alternative embodiments of a plurality of spice dispenser compartments, e.g., four spice dispenser compartments 170A-170D are positioned and aligned with the front plane of the cooking device, so that the user can more easily and rapidly fill each spice dispenser compartment with ingredients, in the same manner that the ingredient dispenser compartments 166A and 166B are aligned with the front plane. In one such embodiment the spice dispenser compartments 170A-170D may be vertically stacked like drawers, which a user can front load with spices, and the robotic arm can grab a respective handle 1500A-1500D on the backside of the drawers to pull or rearwardly draw the containers and dispense the spices therein in the cooking pot. In another embodiment to increase the number of ingredient dispenser compartments, the dispenser compartments can be arranged in L-, U- or O-shaped fashion.

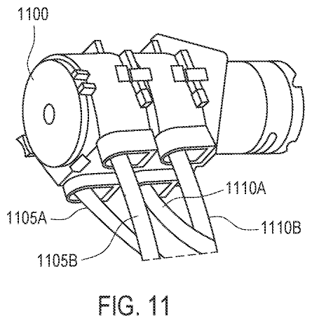

Liquid dispenser compartments 180 and 181 hold liquids, such as oil and water, that may be dispensed into cooking pot 125. The compartments are made of food-grade safe polycarbonate. The area occupied by the liquid dispenser compartments open to or are accessible at the front plane of the cooking device 100 for easy removal and replacement, according to an embodiment. These dispenser compartments include lids (not shown), according to one embodiment. FIG. 3 illustrates a set of one or more tubes 182 connected to a hole or opening in the bottom of liquid dispenser compartment 180. Likewise, a set of one or more tubes 183 are connected to a hole or opening in the bottom of liquid dispenser compartment 181. In each case, the opening, according to one embodiment, is a double barb openings assembly 184 (“double barb 184”), as illustrated in place at the bottom of compartments 180 and 181. The two outlets from the double barb 184 allow liquid from compartments 180 and 181 to respectively flow through food grade tubes 182 and 183 attached thereto to inlets 1105A and 1105B of respective electric pumps 1100, examples of which are shown in FIG. 11. In one embodiment, the electric pumps 1100 are powered by a 24V DC motor both of which are situated in component compartment 117. The pumps include outlets 1110A and 1110B. The outlets 1110A and 1110B allow liquids to be pumped through a set of one or more food grade tubes 186 attached thereto. The other end of the tubes 186 terminate near cooking pot 125. According to one embodiment, liquid dispensing compartments include sensors to detect whether the compartments contain liquid or not. In one embodiment, the sensor is a VL53L5CX sensor, available from STMicroelectronics. According to an alternative embodiment, a housing 187 includes one or more pumps 1110 rather than the pumps being located in component compartment 117. A set of one or more tubes 182 and another set of one or more tubes 183 couple to the inlets of the pump(s) in housing 187, and a set of one or more tubes 186 couple to the outlets of the pump(s) and are routed from the pump(s) within housing 187 to their respective outlets situated near cooking pot 125.

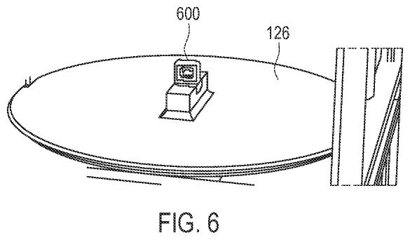

With reference to FIG. 2, the lid 126 sits atop elevated platform 116 at various times during the cooking process, the space for such is optimally utilized, according to embodiments. During other times of the cooking process, the lid 126 is placed on cooking pot 125, for example, to save energy and reduce the cooking time of a given recipe. A user can choose to manually remove the pot lid off during the entire cooking process. FIG. 6 shows a detailed view of lid 126. The lid comprises a handle 600 which is similar to the handles 400 on dispenser compartments 166A and 166B, so that the robotic arm/gripper assembly can grip the handle and maneuver the lid 126 in the same manner as it does the dispenser compartments 166A and 166B and/or the utensil 190, as described elsewhere herein. In one embodiment, handle 600 comprises a hole by which the robotic arm/gripper assembly can latch on to and hold the lid. Since lid 126 is circular, the angle of the handle 600 is set by simply rotating the lid to an angle aligned with the robotic arm/gripper assembly. Alternatively, an alignment pin on the lid and a groove on the pot can be used to correctly orient the angle of the handle 600 accordingly. In an alternative embodiment, the cooking pot 125 and lid are not circular. For example, the cooking pot and lid may be oval or rectangular, in which case, the angle of handle 600 is fixedly angled or oriented toward the robotic arm/gripper assembly so that a robotic arm having only five degrees of freedom or rotation is able to pick up, maneuver, and return the lid to cooking pot 126 or elevated platform 116. According to one embodiment, the approximate diameter of the lid is 305 mm. Thus, the cooking pot 125, too, has a similar diameter, approximately 310 mm, about its rim. The cooking pot, according to one embodiment, has a height of approximately 95 mm.

According to an embodiment, the cooking pot is positioned within a cooking pot alignment ring 185. In one embodiment, the height of the cooking pot ring 185 is 5 cm over the hot plate and is 5 to 10 cm away from the outer diameter of the hotplate. The cooking pot alignment ring 185 ensures the cooking pot does not move much when a utensil, wielded by the robotic arm 145, is stirring the ingredients inside the cooking pot. The cooking pot alignment ring also ensures the position of the cooking pot is constant when the robotic arm dispenses ingredients from ingredient dispenser compartments into the cooking pot. In one embodiment, the diameter of the cooking pot alignment ring is 210 mm.

As previously mentioned, at selected times, the robotic arm 145 removes the lid, lifts a utensil such as a spoon or spatula and stirs the ingredients inside the cooking pot. FIGS. 1 and 2 illustrate a utensil holder 190, and the utensil 191, e.g., a spatula. Utensil 191 may also contain a hole for the robotic arm 145/gripper assembly 156 to grip and hold the utensil. According to one embodiment, the holder 190 and utensil are stainless steel 316L. The x,y,z coordinates in the robotic workspace is aware of the location of the utensil 191. In one embodiment, utensil 191 is approximately 200 mm×75 mm×7 mm in dimensions.

A camera and depth sensor 195 is mounted to frame 105 in a location and with a sufficient field of view (FOV) to track the movements of the robotic arm 145/gripper assembly 156 as well as any foreign objects that may interfere with the operation of such to comply with safety standards such as IEC-60335. The camera and depth sensor 195 tracks the location and movement of dispenser compartments, utensils, and the lid, according to embodiments. According to one embodiment, the dispenser compartments are made of clear food grade material so that the camera can also detect the presence or absence of ingredients in each dispenser compartment. Additionally, according to one embodiment, a sensor such as the VL53L5CX sensor available from STMicroelectronics, can be integrated with the robotic arm 145 for collision detection and avoidance. According to another embodiment, one or more accelerometers and/or gyroscopes may be co-located with the gripper assembly 156 to detect and monitor its location for the robotic arm's accurate maneuverability using simultaneous localization and mapping (SLAM), forward and inverse kinematics algorithms.

According to yet another embodiment, the cooking device comprises a weighing scale mechanism, including computer software, that when executed, receives input from the camera(s) to detect an amount of deflection in the robotic arm 145 when it grasps and lifts a dispenser compartment, and based thereon, calculates a weight of ingredients in a dispenser compartment. According to this embodiment, the amount of robotic arm deflection is pre-calibrated, essentially learning and mapping various deflections in the robotic arm according to various weights in the dispenser compartments, and then the camera captures deflection of the robotic arm when in actual use and derives the weight of the ingredients in a dispenser compartment by comparing the captured amount of deflection with the learned deflection mappings. Alternatively, the amount of deflection in the robotic arm can be calculated using information provided by a six degrees of motion (6DoF) IMU (inertial measurement unit) along with a number of pulses (sent to the stepper motor) needed to cause the robotic arm to lift a dispenser compartment.

Knowing the weight of ingredients allows for programmatically calculating the cooking time and temperature for the ingredients in the dispenser compartment, thus allowing the user to avoid need to entering cooking time and temperatures manually through a user interface such as touch screen 102. Additionally, such an embodiment also helps in programmatically calculating the amount (i.e., weight) of particular ingredients that should be dispensed in the cooking pot to make a certain dish for certain or selected number of people. For example, a given quantity of onion is needed to make a single serving of a certain dish or meal. Thus, even if a food ingredient dispenser compartment contains sufficient onions for, say, four servings, but the cooking device is programmed to provide a single serving, only the needed quantity of onions to cook a single serving of a particular meal is actually dispensed into the cooking pot.

With reference to FIGS. 1-3, the robotic arm enjoys five degrees of freedom. The robotic arm has a base 140. In one embodiment the base is aluminum. The robotic arm is mounted to the base and has five articulating joints 151, 152, 153, 154 and 155 by which different respective segments 151S, 152S, 153S, 154S and gripper assembly 156 of the robotic arm 145 are linked and rotated or moved. In one embodiment, a first joint 151 provides for rotation of a first segment 151S of robotic arm 145 about a substantially vertical axis, thereby generally rotating or moving the first segment 151S, and thus, the robotic arm 145 and by extension the gripper assembly 156 to the left and to the right about the substantially vertical axis of the base 140. In one embodiment, a second joint 152 provides for rotation of a second segment 152S about a substantially horizontal axis, thereby generally rotating or moving the second segment 152S, and thus, the robotic arm 145 and by extension the gripper assembly 156, forward and backward relative to base 140. In one embodiment, a third joint 153 provides for rotation of a third segment 153S about a substantially horizontal axis, thereby generally rotating or moving the third segment 153S, and thus, the robotic arm 145 and by extension the gripper assembly 156, up and down and/or forward or backward relative to base 140, depending on the position of the second segment 152S as controlled by second joint 152. In one embodiment, a fourth joint 154 provides for rotation of a fourth segment 154S about a substantially horizontal axis, thereby generally rotating or moving the fourth segment 154S, and thus, the robotic arm 145 and by extension the gripper assembly 156, up and down and/or forward or backward relative to base 140, depending on the position of the second segment 152S as controlled by second joint 152, and/or the position of the third segment 153S as controlled by third joint 153. Finally, a fifth joint 155 provides for rotation of the gripper assembly 156 about an axis that is substantially parallel to the plane or angle of the fourth segment 154S. The plane or angle of the fourth segment 154S varies according to the location in space to which the fourth joint 154 has positioned the fourth segment 154S by rotating about its substantially horizontal axis, as well as the locations in space in which the first joint 151, second joint 152, and third joint 153 have positioned the respective first segment 151S, second segment 152S, and third segment 153S. Accordingly, gripper assembly 156 may be positioned up, down, left, right, forward, or backward, to the extent needed in order to grip on to and secure any one of the handles 400 of the various dispenser compartments 166A and 166B, utensils 172 and 191, and cooking lid 126 described herein.

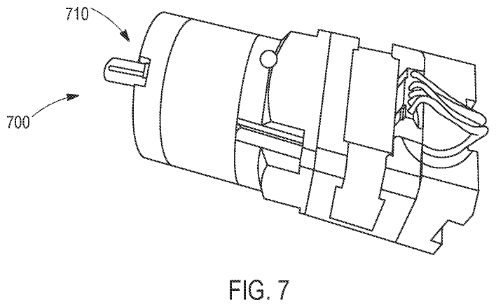

A gripper assembly 156 is connected to joint 155, which functions in much the same manner as a wrist joint to manipulate and maneuver gripper assembly 156 to pick up and move various components of the cooking device such as dispenser compartments, utensils, and the cooking pot lid 126. In one embodiment, the gripper assembly 156 consists of a stationary finger and a movable finger to form a hook. Each joint is controlled by a respective, co-located servo- or stepper motor, and an associated controller in electrical connection with the servo- or stepper motor situated in component compartment 117. The gripper movable finger is controlled by a servo motor, while other joints are controlled by a stepper motor and associated encoder, according to an embodiment. According to an embodiment, the covers on the stepper motors are made of food grade safe plastic. The movable finger likewise is controlled by a servo motor and associated controller. An example stepper motor 700 including a reducer is depicted in FIG. 7. According to one embodiment, the stepper motor includes a reducer to generate high torque. According to an embodiment, the stepper motor may be a NEMA17 stepper motor with 100:1 reducer (reducer from STEPPERONLINE).

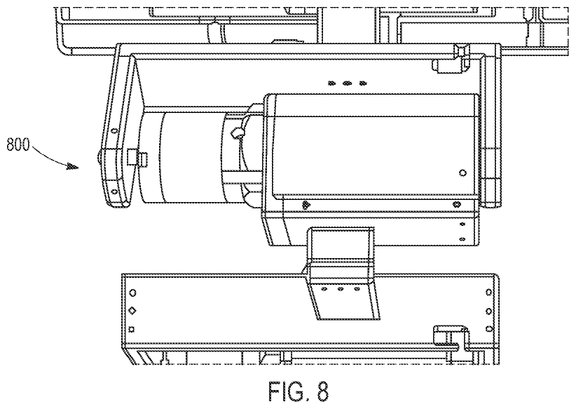

FIG. 8 depicts a robotic joint 800, such as one of joints 151, 152, 153, 154, or 155 and associated stepper motor. In another embodiment, the stepper motor can be located near the base 140 and drive the associated joint through pulleys and a timing belt, to meet increased torque requirements. As illustrated, each joint is actuated by a separate stepper motor. According to one embodiment, each stepper motor includes a reducer with a planetary (or harmonic gear box for zero backlash) gear box sufficient to generate enough torque to lift dispenser compartments fully loaded with ingredients that may weigh up to, e.g., two pounds, and to generate the force necessary to maneuver the utensil 191 sufficient to stir ingredients in the cooking pot 125. According to embodiments, a gear reduction ratio of 100 is used in joints 151, 152, 153 and 154, which is sufficient to meet the torque requirements of the cooking device. Additionally, a reduction ratio of 100 provides sufficient inertia at no power such the that robotic arm joints do not collapse at power off, which makes recovery after power off straightforward as the angle values for each joint are stored in a nonvolatile store, e.g., an EEPROM, of the computing device that controls robotic arm 145.

The reducers for each stepper motor are high precision with a backlash of less than 30 arcmin, which is sufficient for repeatability and good alignment every time the robotic arm maneuvers, according to embodiments.

Each stepper motor has a shaft 710 as depicted in FIG. 7. The opposite side of the shaft is supported by a bearing which aligns with the stepper motor and a shaft link with dowel pin of size 20 mm. Such an embodiment provides robustness and support of the robotic arm joints. The stepper motor for each joint includes an electronic encoder which makes the stepper motor rotate according to a closed loop feedback mechanism, ensuring the steps or pulses sent by an associated computing device are received by the stepper motor. An accelerometer and/or gyroscope may add accuracy and repeatability to the operations with the encoder on the stepper motor.

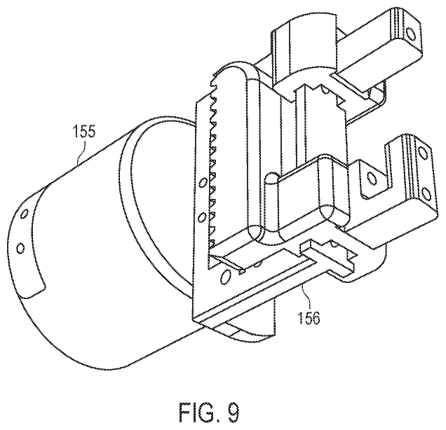

FIG. 9 illustrates joint 155 in more detail. In one embodiment, joint 155 has gear reduction ratio of 10. Alternatively, it has a reduction ratio of 20 for higher torques with a slight increase in the length of joint 156. Gripper assembly 156 is connected to joint 155. In this embodiment, the gripper assembly is connected to the end of the shaft comprising joint 155, whereas the embodiment depicted in FIGS. 1-3 depict the gripper assembly 156 connected to the side of the shaft comprising joint 155. The embodiment of gripper assembly 156 depicted in FIG. 9 reduces torque requirements compared to the embodiment depicted in FIGS. 1-3 while increasing the length of the joint 155. Gripper assembly 156 mounted on the side of joint 155 reduces the length of joint while increasing the torque requirement (which is equal to force times distance) to hold a given weight. According to one embodiment, a computing device sends instructions to a servo motor (not shown in the picture) to operate joint 155.

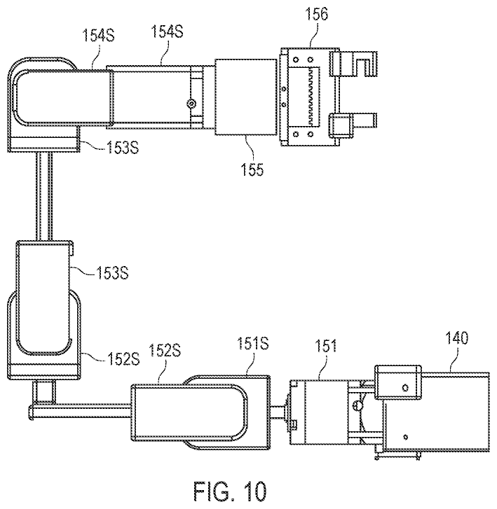

FIG. 10 depicts the robotic arm 145 with dimensions from axis to axis, according to one embodiment. Joint 155 can be 180 mm in length with configuration shown in FIG. 1-3, or 222 mm with the configuration shown in FIG. 9.

According to an embodiment, the cooking device includes a base plate, for example, a galvanized steel plate. Heat radiated by the hotplate is absorbed and dissipated by the base plate. Slip resistant rubber feet or studs attached to an underneath side of the base plate ensures there is air gap between the base plate and the surface on which the machine rests.

According to embodiments, the mechanical parts of the cooking device that come into contact with food comprise one of 316L stainless steel, aluminum with nickel plating, HDPE (High Density Polyethylene), polycarbonate or ABS (acrylonitrile-butadiene-styrene), or other food grade safe materials, for example, as per FDA standards.

According to one embodiment, the height of the cooking device 125 is 500 mm, the width is 675 mm and the depth is 600 mm, making the device quite suitable for home kitchen countertop placement and operation. The height, width and depth can vary by +/−50 mm in any one or more of the dimensions to adjust the capacity of the amount of food to cook. This form factor makes the cooking device portable and pluggable into a home kitchen power outlet which is fitted with 20 Amp GFCI (Ground Fault Circuit Interrupter).

### Electronic/Electrical Structure

Compartment 117 is located behind liquid dispenser compartments 180 and 181, as illustrated in FIGS. 1-3. The compartment comprises a power supply, such as a 15 Amp, 110V AC to 24 DC convertor power supply, which powers a computing device, such as a STM32 ARM based microcontroller and a Raspberry Pi4 based microprocessor like CM4 (compute module 4). According to an embodiment, the microcontroller controls the stepper motors, temperature sensor and control, and the microprocessor handles the computation of cognitive aspects like computer vision, Simultaneous Localization and Mapping (SLAM), object detection and collision avoidance through camera, depth/proximity sensor, and control of Inertial Measurement Unit (IMU)s (not shown) for each stepper or servo motor. A PCB (printed circuit board), Manta MBP, available from Shenzhen Bique Technology Co., LTD., carries support for the STM32 microcontroller as well as the Raspberry Pi-CM4 microprocessor. In another embodiment, the PCB is an SKR3 with STM32 microcontroller and PI4B PCB which mounts the CM4 Raspberry Pi microprocessor. The PCB board supports up to 8 stepper motor drivers, a PT100/PT1000 resistance type temperature sensor for a 400 degrees C. range with good accuracy. The MCU board supports camera interfaces and depth sensor interfaces as well as a Wi-Fi on chip module to enable app-based control of the cooking device through a mobile phone or computing device and to enable software updates for the cooking device through internet. Wi-fi capability provides the ability for users to share their recipes on the cloud and check the status of the cooking process in real time through the device's camera. The MCU board powers two 24V DC motor pumps 1110 (illustrated in FIG. 11) for various liquids, such as water and oil. The 24V DC motor pumps have two 3-4 mm diameter tube inlets and outlet each.

The PCB supports a display screen 102, such as an LCD (liquid crystal display) touch screen which runs on an CM4 microprocessor, according to one embodiment. The LCD touch panel may also run on STM32 based microcontrollers, or on an SKR3 board available from Shenzhen Bique according to an embodiment.

According to one embodiment, a heating coil for electric hotplate 120 is powered by 110V AC which is controlled through 15 amp solid state switch. The solid-state switch powers on or off the heating coil based on the temperature read by the temperature sensor and the temperature set via the LCD touch screen 102.

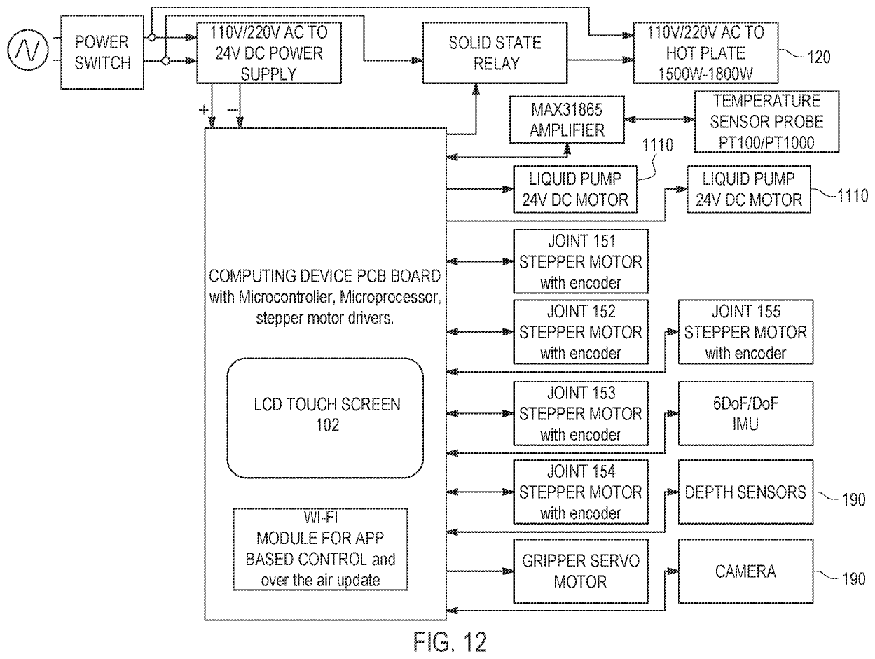

According to an embodiment, the stepper motor drivers are operated according to a closed loop encoder chip. Thus, the computing device and/or depth sensors (for end effector location) need only send electrical pulses to rotate the robotic joint for desired angle. The camera (and/or depth sensors) and stepper motor encoder mechanism ensure a feedback loop for the robotic arm to control its location and/or joint angle correction. FIG. 12 provides a block diagram of the electrical and electronic components in cooking device 100 and their interconnections. In another embodiment accelerometers and a gyroscope along with a camera and/or depth sensors can provide a feedback loop for the robotic arm control.

### Software Structure

According to one embodiment, the firmware that powers the STM32 Arm cortex along with LCD was developed using STM32CubeIDE in C and C++ programming language. STM32CubeIDE is tool suite by ST Microelectronics for embedded development.

An inverse kinematics algorithm identifies joint angles of the robotic arm. Since the location of all the ingredient dispenser compartments, spice dispenser compartments, utensils, and the cooking pot lid are fixed and known, it is straightforward to plan the path or trajectory of the robotic arm 145. Tracking of the robotic arm path is accomplished by camera and depth sensors 195. A camera interface and depth sensors interface are controlled by the powerful microprocessor CM4, available from Raspberry, according to an embodiment. Inverse kinematics and Computer Vision computations for depth, ingredient detection, utensil stir level are also carried out by the microprocessor, while the stepper motor control and temperature sensor control are carried out by the STM32 microcontroller.

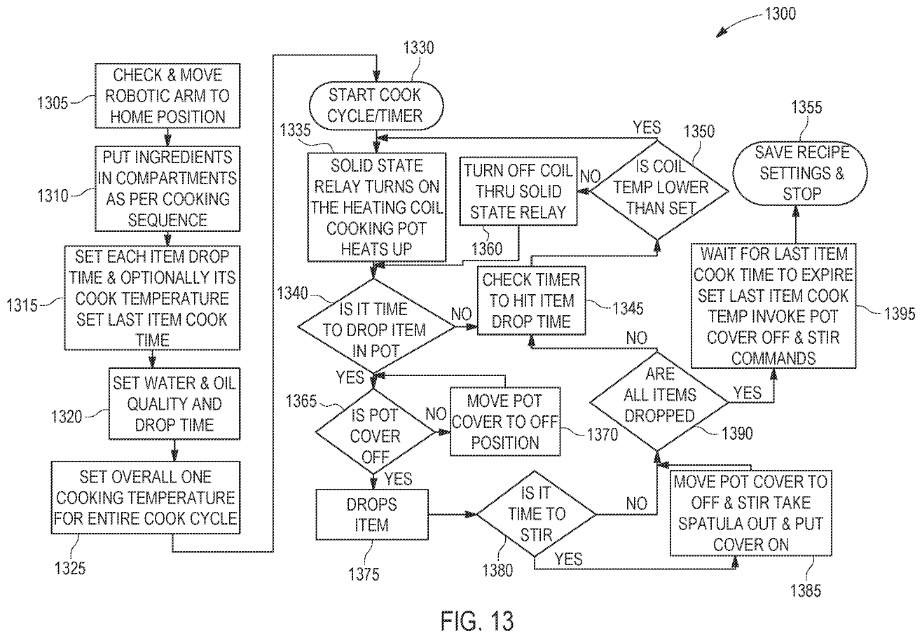

FIG. 13 provides a flowchart 1300 of the cooking process. Software executing on microcontrollers manipulates and moves the robotic arm, dispenser compartments, cooking lid, and cooking utensils as needed during the cooking process, according to the following steps. The cooking cycle can be paused or canceled through user input via a user interface such as the LCD touch screen 102 at any time during the cooking cycle according to the user's choice or other situations, such as, during an emergency situation. At step 1305, the process checks the location of the robotic arm 145, and if needed, positions the robotic arm to a start or home location. According to one embodiment, this step is performed at the end of the previous cooking cycle, and so may not need to be performed as the first step in a new cooking cycle, so long as the robotic arm 145 does not move or get moved between the previous cooking cycle and the present cooking cycle. For example, if there is an electronic and/or mechanical locking mechanism that prevents movement of the robotic arm between cooking sessions, then this step may not need to be performed on or before power up of the cooking device for a present cooking cycle. In one embodiment, the step is performed manually by the user or may be performed by the cooking device once powered on as part of a start-up or initiation sequence of steps.

At step 1310, a user places ingredients in one or more of dispenser compartments, for example, one or more of dispenser compartments 166A, 166B, 170, 180 and 181. At step 1315, the user selects or inputs the time at which to drop, or dispense, the ingredients in the one or more dispenser compartments into cooking pot 125. In one embodiment, the times at which to dispense ingredients may be specified in terms of and actual date and times, e.g., Dec. 1, 2022, at 4:00 PM, 4:15 PM, . . . 4:45 PM, etc., or may be specified as offsets from a selected start date and time, e.g., start cooking on Dec. 1, 2022, at 4:00 PM, and dispense ingredients in a first dispenser compartment 15 minutes thereafter, and dispense ingredients in a second dispenser 45 minutes thereafter, etc.

Alternatively, or additionally, at step 1315, the user may input or select the cooking temperature at one or more of each ingredient dispensing time, as well as the duration of time for such cooking temperature. Finally, at step 1315, the user may optionally input the cooking time for the last ingredient(s) dispensed into cooking pot 125. In this manner, the cooking device 100 stops cooking/turns off the hotplate 120, upon lapse of the cooking time for the last ingredient dispensed into the cooking pot. At step 1320, a user may load liquid dispenser compartments with oil, water, or other liquid, and further indicate via the user interface when to drop, or pump, such contents into the cooking pot. At step 1325, a user may optionally configure a single cooking temperature for the entire cooking process. For any one of steps 1315, 1320 and 1325, the user may additionally input corresponding instructions to stir one or more times the ingredients once or after they are dispensed at their respective times, and/or when the temperature of the hotplate is set, increased, or decreased.

At step 1330, the user presses start, or if a delayed or deferred start cooking time is input, the cooking device automatically turns on once that the period of delay has expired. At 1335, a solid-state relay switch or the like turns on electric hotplate 120, or a heating coil, so that the cooking pot reaches a selected cooking temperature. At step 1340, the cooking device checks or queries the time at which to drop or dispense an ingredient from a dispensing compartment into the cooking pot 125 as configured in step 1315. If it is not yet time to dispense an ingredient, the cooking device 125 continues to monitor the elapsed time at 1345, as well as checking the hotplate temperature at 1350 and turning on/off the hotplate or heating coil at steps 1335 and 1360 as needed to regulate the correct or specified cooking temperature. Once a determination is made to dispense an ingredient, the process moves on to step 1365, where a determination is made whether the cooking pot lid 126 is on or off the cooking pot. For example, the cooking device uses camera and depth sensors 195 to check the location of the lid. If the lid is on the cooking pot, the process moves to step 1370, wherein robotic arm 145 is controlled to position the gripper assembly 156 into place to pick up the cooking pot lid by its handle and move the cooking pot lid to surface 116. Once the cooking pot lid is removed, the robotic arm, at step 1375, is controlled to position the gripper assembly 156 into place to pick up one of the dispenser compartments 166A, 166B by its respective handle 400, lift and move the dispenser compartment over to the cooking pot, then tip over the dispenser compartment to dislodge the ingredients stored therein and place them into cooking pot 125. In particular, according to an embodiment, the cooking device identifies and selects one of the dispenser compartments, then controls the robotic arm to grab by its handle, and vertically lift, the dispenser compartment so that the bottom of the compartment at least clears, i.e., is above, the top edge of its respective compartment alignment ring 165, then horizontally transfers or shifts the position of the lifted compartment in a direction toward the back plane of the cooking device such that the front face of the compartment has cleared, i.e., is behind, the rear face of adjacent compartment. The cooking device then controls the robotic arm to swing the dispenser compartment to a position over the top of the cooking pot, and then tips over the dispenser compartment to dispense the ingredients stored therein into the cooking pot.

At step 1380, the process checks whether it is time to stir the contents of the cooking pot 125 based on user input regarding the same, for example, provided at steps 1315, 1320 and/or 1325. Once a determination is made to stir the contends of the cooking pot, the process moves on to step 1385, where a determination is made whether the cooking pot lid 126 is on or off the cooking pot. For example, the cooking device uses camera and depth sensors 195 to check the location of the lid. If the lid is on the cooking pot, the process controls robotic arm 145 to position the gripper assembly 156 into place to pick up the cooking pot lid by its handle and move the cooking pot lid to surface 116, just like in step 1370. Once the cooking pot lid is removed, the robotic arm 145 is controlled to position the gripper assembly 156 into place to pick up a utensil 191 at utensil holder 190, lift the utensil from the holder, move the utensil over to the cooking pot, lower the utensil into the cooking pot, then move the utensil around to stir the contents of cooking pot 125. The process then controls the robotic arm 145 to lift and return the utensil to the utensil holder 190 and moves on to step 1390 where the cooking device 125 continues to monitor the elapsed time and/or whether all ingredients have been dispensed into the cooking pot. If, however, it is not yet time to stir the contents, the cooking device 125 moves directly to step 1390 where it continues to monitor the elapsed time and/or whether all ingredients have been dispensed into the cooking pot.

At step 1390, the process monitors whether all ingredients have been dispensed into cooking pot 125. If not, the process returns to step 1345 and proceeds as discussed above with respect to that step. Otherwise, if all ingredients have been dispensed, the process moves to step 1395, where the cooking device 100 waits for the cooking time for the last dispensed ingredient to elapse. During this period of time, the process may invoke changes in temperature based on inputs at steps 1315, 1320 and/or 1325, removal and replacement of cooking pot lid 126, and stirring the contents of cooking pot 125, as described above. Once the cooking cycle is completed, cooking is stopped at step 1355. Recipe settings may be saved at this time, if not already, so that they are available for reuse, either in memory at the cooking device or in the cloud. The robotic arm may be positioned up and out of the way of cooking pot 125, and optionally locked into a start position, so that cooking pot lid 126 and/or cooking pot 125 can be easily removed to serve the cooked food, and so the robotic arm 145 is ready to be manipulated or controlled in the next cooking cycle. According to one embodiment, the articulating joints of robotic arm 145 can be made stable at power off or power down so that the robotic arm does not collapse. One way to accomplish this is to short the two terminals of the coil of the stepper motor for each joint when the power is off. Shorting the terminals (e.g., by connecting the coil terminals together) increases the holding torque (at power off) on the stepper motor axle. According to one embodiment, using a 100:1 reducer, the holding torque amplifies through the reducer and makes the robotic joint remain in place. According to an embodiment, the shorting of the two coil terminals of the stepper motor coil can be achieved using an off the shelf integrated circuit (IC), such as the NLAST4599 low voltage single supply SPDT analog switch available from Onsemi. Essentially, when the power is off, the NC & COM terminals of the IC are shorted, and at power on these terminals are disconnected. This is similar to the relay switch which connects two terminals at power off and disconnects the two terminals at power on.

While FIG. 13 illustrates the process steps for cooking a dish or meal according to a user's own recipe. Embodiments also provide for loading recipes stored in the memory of the cooking device or selecting and downloading a recipe from the internet or the cloud. In such a scenario, the process skips the user input steps 1315, 1320 and 1325 in FIG. 13; instead, the user places the ingredients in the various dispenser compartments as per the quantity specified by the saved or downloaded recipe and hits the start button.

The computing device can include memory. In various examples, the memory can include system memory, which may be volatile (such as RAM), non-volatile (such as ROM, flash memory, non-volatile memory express (NVMe), etc.) or some combination of the two. The memory can further include non-transitory computer-readable media, such as volatile and nonvolatile, removable and non-removable media implemented in any method or technology for storage of information, such as computer readable instructions, data structures, program modules, or other data. System memory, removable storage, and non- removable storage are all examples of non-transitory computer-readable media. Examples of non-transitory computer-readable media include, but are not limited to, RAM, ROM, EEPROM, flash memory or other memory technology, or any other non-transitory medium which can be used to store desired information, and which can be accessed by the computing device. Any such non-transitory computer-readable media may be part of the cooking device 100.

The computing device can also have or be connected in communication with one or more communication interfaces. The communication interfaces can include transceivers, modems, interfaces, antennas, telephone connections, and/or other components that can transmit and/or receive data over networks, telephone lines, or other connections. For example, the communication interfaces can include one or more network cards that can be used to receive or transmit recipes or programs for controlling the cooking device and its various components such as the robotic arm and/or user interface, e.g., the LCD touch screen. SPI, UART, I2C, USB-OTG are various communication interface protocols over which all the peripherals like depth sensors, camera, Inertial Measurement Unit (6/9 DoF), LCD touch screen and stepper motor with encoder communicate with computing device.

The computing device may also include a solid-state drive unit including a machine readable medium. The machine-readable medium can store one or more sets of instructions, such as software or firmware, that embodies any one or more of the methodologies or functions described herein. The instructions can also reside, completely or at least partially, within the memory, microcontroller, and/or communication interface(s) during execution thereof by the microcontroller. The memory and the microcontroller also can constitute machine readable media.

During the cooking cycle progress, a foreign object may be detected using the camera and depth sensors. The robotic arm will halt if a foreign object is detected within the vicinity of the cooking device. This foreign object detection and collision avoidance mechanism executes in parallel using multi-tasking/multi-threading capabilities of the computing device.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A cooking device, comprising:
a power supply;
a cooking pot;
a hot plate connected to the power supply and on which the cooking pot sits, the hot plate to apply heat to the cooking pot;
a plurality of food ingredient dispenser compartments located in adjacent, upright, positions, aligned in a row at a front plane of the cooking device;
a robotic arm consisting of five articulating joints providing the robotic arm with five corresponding degrees of motion; and
a computing device connected to the robotic arm to control the robotic arm to move the robotic arm according to the five degrees of motion to separately grasp and hold on to each of the plurality of upright food ingredient dispenser compartments, lift each grasped food ingredient dispenser compartment from its respective position in the row at the front plane of the cooking device, move each lifted food ingredient dispenser compartment to a position above the cooking pot, and rotate each lifted food ingredient dispenser compartment from its upright position substantially about a horizontal axis while positioned above the cooking pot to dispense food ingredients stored therein into the cooking pot.

2. The cooking device of claim 1, wherein the computing device further to control the robotic arm to rotate each lifted food ingredient dispenser compartment back to its upright position substantially about the horizontal axis after the food ingredients stored therein have been dispensed into the cooking pot, return each lifted food ingredient dispenser compartment to its respective upright position in the row at the front of the cooking device, and release its grasp on each food ingredient dispenser compartment.

3. The cooking device of claim 1, further comprising a cooking lid, wherein the computing device connected to the robotic arm to control the robotic arm to move the robotic arm according to the five degrees of motion to separately grasp and hold on to the cooking lid, lift the cooking lid from a position on top of the cooking pot, and move the cooking lid to a position aside the cooking pot.

4. The cooking device of claim 3, further wherein the computing device connected to the robotic arm to control the robotic arm to move the robotic arm according to the five degrees of motion to return the cooking lid from the position aside the cooking pot to the position on top of the cooking pot and release its grasp on to the cooking lid.

5. The cooking device of claim 1, further comprising a plurality of spice dispenser compartments and a spices utensil with which to scoop spices stored therein and dispense the same in the cooking pot, wherein the computing device connected to the robotic arm to control the robotic arm to move the robotic arm according to the five degrees of motion to grasp and hold on to the spices utensil, maneuver and manipulate the spices utensil to scoop and hold spices from one or more of the plurality of spice dispenser compartments, move the spices utensil to a position above the cooking pot while holding the spices, and rotate the spices utensil substantially about a horizontal axis while positioned above the cooking pot to dispense the spices held therein into the cooking pot.

6. The cooking device of claim 1, further comprising a cooking pot utensil with which to stir contents in the cooking pot, wherein the computing device connected to the robotic arm to control the robotic arm to move the robotic arm according to the five degrees of motion to grasp and hold on to the cooking pot utensil, and maneuver and manipulate the cooking pot utensil to stir the contents in the cooking pot.

7. The cooking device of claim 1, further comprising:
a plurality of liquid dispenser compartments each having an outlet;
a corresponding plurality of electric pumps each having an inlet and an outlet;
a first plurality of tubes connected to the outlets of the plurality of liquid dispenser compartments and to the inlets of the corresponding plurality of electric pumps; and
a second plurality of tubes having first ends connected to the outlets of the plurality of electric pumps and second ends that are open adjacent the cooking pot, wherein the computing device controls the plurality of pumps to pump liquid from the liquid dispenser compartments via the first plurality of tubes and the second plurality of tubes to the cooking pot.

8. The cooking device of claim 1, further comprising a user, programmatic, and/or communications interface via which to receive instructions that direct the computing device to control when the robotic arm to move the robotic arm according to the five degrees of motion to separately grasp and hold on to each of the plurality of upright food ingredient dispenser compartments, lift each grasped food ingredient dispenser compartment from its respective position in the row at the front of the cooking device, move each lifted food ingredient dispenser compartment to a position above the cooking pot, and rotate each lifted food ingredient dispenser compartment from its upright position substantially about a horizontal axis while positioned above the cooking pot to dispense food ingredients stored therein into the cooking pot.

9. The cooking device of claim 1, further comprising a user or communications interface via which to receive instructions to direct the computing device to control when and for how long to apply heat to the hot plate.

10. The cooking device of claim 5, further comprising a user, programmatic and/or communications interface via which to receive instructions to direct the computing device control the robotic arm to move the robotic arm according to the five degrees of motion to grasp and hold on to the spices utensil, maneuver and manipulate the spices utensil to scoop and hold spices from one or more of the plurality of spice dispenser compartments, move the spices utensil to a position above the cooking pot while holding the spices, and rotate the spices utensil substantially about a horizontal axis while positioned above the cooking pot to dispense the spices held therein into the cooking pot.

11. The cooking device of claim 6, further comprising a user, programmatic or communications interface via which to receive instructions to direct the computing device to control the robotic arm to move the robotic arm according to the five degrees of motion to grasp and hold on to the cooking pot utensil, and maneuver and manipulate the cooking pot utensil to stir the contents in the cooking pot.

12. A method for an automated cooking device to cook a meal, comprising:
receiving at a computing device of the cooking device input regarding a plurality of times at which to dispense into a cooking pot of the cooking device a corresponding plurality of ingredients stored in a plurality of dispenser compartments of the cooking device, a corresponding cooking temperature, and a cooking duration, for cooking each of the dispensed plurality of ingredients;
dispensing at the plurality of times the corresponding plurality of ingredients into the cooking pot, by a robotic arm of the cooking device that grab and moves the plurality of dispenser compartments from a resting position to a position over the cooking pot, and tips the plurality of ingredients stored in the plurality of dispenser compartments into the cooking pot while positioned over the cooking pot, under the control of the computing device, according to the received input;
applying a heat source for the cooking device to the cooking pot according to the plurality of times at which the plurality of ingredients is dispensed into the cooking pot, the corresponding cooking temperatures, and the cooking durations, for cooking each of the dispensed plurality of ingredients.

13. The method of claim 12, wherein receiving at the computing device input regarding the plurality of times at which to dispense into a cooking pot of the cooking device a corresponding plurality of ingredients stored in a plurality of dispenser compartments of the cooking device, a corresponding cooking temperature, and a cooking duration, for cooking each of the dispensed plurality of ingredients comprises receiving input from one of a user interface, a communications interface, and a programmatic interface.

14. The method of claim 12, further comprising:
removing a cooking lid from the cooking pot, by the robotic arm, prior to dispensing at the plurality of times the corresponding plurality of ingredients into the cooking pot, by the robotic arm; and
replacing the cooking lid on the cooking pot, by the robotic arm, after dispensing at the plurality of times the corresponding plurality of ingredients into the cooking pot, by the robotic arm.

15. The method of claim 12, further comprising:
receiving at the computing device of the cooking device input regarding a plurality of times at which to stir the plurality of ingredients dispensed into a cooking pot of the cooking device; and
stirring, by the robotic arm gripping a stirring utensil, the plurality of ingredients dispensed into the cooking pot at the plurality of times at which to stir the plurality of ingredients.

16. The method of claim 15, further comprising:
removing a cooking lid from the cooking pot, by the robotic arm, prior to the plurality of times at which to stir the plurality of ingredients dispensed into the cooking pot, by the robotic arm; and
replacing the cooking lid on the cooking pot, by the robotic arm, after the plurality of times the corresponding plurality of ingredients are stirred in the cooking pot, by the robotic arm.

17. The method of claim 12, further comprising:
receiving at the computing device of the cooking device input regarding a plurality of times at which to dispense into a cooking pot of the cooking device a corresponding plurality of spices; and
dispensing at the plurality of times the corresponding plurality of spices into the cooking pot, by a robotic arm of the cooking device that grabs and moves the plurality of spices to a position over the cooking pot, and tips the plurality of spices into the cooking pot while positioned over the cooking pot, under the control of the computing device, according to the received input.

18. The method of claim 17, wherein:
receiving at the computing device of the cooking device input regarding a plurality of times at which to dispense into a cooking pot of the cooking device a corresponding plurality of spices comprises receiving at the computing device of the cooking device input regarding a plurality of times at which to dispense into a cooking pot of the cooking device a corresponding plurality of spices stored in a plurality of spice dispenser compartments of the cooking device; and
wherein dispensing at the plurality of times the corresponding plurality of spices into the cooking pot, by a robotic arm of the cooking device that grabs and moves the plurality of spice to a position over the cooking pot, and tips the plurality of spices into the cooking pot while positioned over the cooking pot, under the control of the computing device, according to the received input comprises dispensing at the plurality of times the corresponding plurality of spices into the cooking pot, by a robotic arm of the cooking device that grabs and moves the plurality of spice dispenser compartments from a resting position to a position over the cooking pot, and tips the plurality of spices stored in the plurality of spice dispenser compartments into the cooking pot while positioned over the cooking pot, under the control of the computing device, according to the received input.

19. The method of claim 17, wherein:
receiving at the computing device of the cooking device input regarding a plurality of times at which to dispense into a cooking pot of the cooking device a corresponding plurality of spices comprises receiving at the computing device of the cooking device input regarding a plurality of times at which the robotic arm grabs a spices utensil and scoops from a spices dispenser compartment the plurality of spices to dispense into the cooking pot; and
dispensing at the plurality of times the corresponding plurality of spices into the cooking pot, by the robotic arm of the cooking device that moves the spices utensil to a position over the cooking pot, and rotates the utensil thereby tipping the plurality of spices in the spices utensil into the cooking pot while positioned over the cooking pot, under the control of the computing device, according to the received input.

20. The method of claim 12, further comprising:
receiving at the computing device input regarding a plurality of times at which to pump into the cooking pot of the cooking device a corresponding plurality of liquid ingredients stored in a plurality of liquid dispenser compartments of the cooking device; and
dispensing at the plurality of times the corresponding plurality of liquid ingredients into the cooking pot, by a pump that transfers the plurality of liquid ingredients from the liquid dispenser compartments to the cooking pot, according to the received input.
